(19) United States
(12) Patent Application Publication
(10) Pub. No.: US 2023/0264824 A1
(43) Pub. Date: Aug. 24, 2023

(54) ELECTRIC FLYING VEHICLE WITH MULTIPLE INDEPENDENT PROPULSION MODULES

(71) Applicant: Ryse Aero Technologies, LLC, Mason, OH (US)

(72) Inventors: Alan Joseph Arkus, Cincinnati, OH (US); Thaddeus Bort, JR., Loveland, OH (US); Zachary Morgan Carlton, Liberty Township, OH (US); Mickey W. Kowitz, Maineville, OH (US); Erik Stephansen, Belvedere, CA (US)

(21) Appl. No.: 18/112,758

(22) Filed: Feb. 22, 2023

Related U.S. Application Data
(60) Provisional application No. 63/312,963, filed on Feb. 23, 2022.

(51) Int. Cl. B64D 27/24; B64C 27/08; B64D 11/06; B60L 53/80

(52) U.S. Cl. CPC B64D 27/24; B64C 27/08; B64D 11/0689; B60L 53/80; B60L 2200/10

(57) ABSTRACT

A flying vehicle with a battery pack associated with each propulsion module, not centrally located, that is plug and play, meaning it can be easily removed by hand and swapped with any other battery of same model and serial number and used within a propulsion module to power the propulsion system. The system includes battery management modules for monitoring battery pack voltage and evenly re-distributes power across all independent battery packs keeping each pack within relative voltage of each other. The packs within the vehicle are monitored for balancing so one pack cannot become too low in power as to not operate while the vehicle's other packs are still working.

This claims the benefit of U.S. Provisional Patent Application Ser. No. 63/312,963, filed Feb. 23, 2022 and hereby incorporated by reference in its entirety.

### BACKGROUND OF THE INVENTION

This invention generally relates to electric flying vehicles, and more particularly to electric flying vehicles with multiple independent propulsion modules containing removable and rechargeable battery packs capable of being balanced among the various packs of the vehicle while in flight.

The utility of vehicles for, but not limited to, agriculture, cattle herding, mining and similar purposes is nothing new; however, the use of an electric vertical takeoff and landing vehicle (eVTOL) that is considered an ultralight vehicle category of aircraft, built in compliance with the FAA's 14 CFR, Part 103 standards to reduce emissions, complexity and safety concerns could prove cost-effective and invaluable to many markets needing to go short distances in a direct line path more quickly to investigate situations and provide timely response.

### SUMMARY OF THE INVENTION

Various embodiments of a single operator electric vertical takeoff and landing transportation vehicle according to this invention are described herein, henceforth referred to as the “vehicle”. In some embodiments there may be a varying number of propulsion modules. The propulsion modules can be as low as two units and the maximum is unlimited and any number of modules in between. The proposed embodiment's design is for optimal operator safety and reduced risk of harm to person and/or the vehicle in such a way that it would no longer be able to operator safely. In any embodiment, the propulsion modules act as standalone units, but have a balancing capability using a voltage bus, connected with a higher resistance wire, designed to keep the battery packs at similar voltages by allowing more current to flow through the wire. The battery bus places all packs in a parallel configuration to optimize power draw and balancing at the same time.

Other aspects of this invention include a seat assembly for use in the vehicle as well as methods and systems of constructing, operating and retrofit modification of vehicles according to aspects of this invention.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1A is a diagram showing an overhead view of one embodiment of a flying vehicle according to this invention;

FIG. 1B is a diagram illustrating one aspect of this invention including a removable battery pack and the propulsion module with structural enclosure for the battery pack to fit into in which the enclosure acts as a floatation device and outrigger float along with motor and propeller mounted to the frame;

FIG. 1C is an illustration of a portable charging station according to one aspect of this invention to house additional battery packs and the ability to charge multiple battery packs at once;

FIG. 1D is a side view demonstrating one aspect of this invention for replacing the battery packs with stored packs and loading the “rundown” packs back into the portable charging station;

FIG. 1E is an illustration to demonstrate possible components within the removable battery pack and in-flight balancing and motor draw characteristics according to various aspects of this invention;

FIG. 1F is a drawing to illustrate the floatation characteristics of the propulsion module and battery pack according to one embodiment of this invention;

FIG. 1G is illustrating the high voltage (HV) wiring scheme of a six-propeller flying vehicle to a central bus;

FIG. 1H is an overview diagram showing the high voltage electrical flow demonstrating the use of wire resistance among the battery pack, propulsion enclosure, high voltage bus and propulsion motor;

FIG. 1I is a diagram of one embodiment of a sealed removable battery pack and its components;

FIG. 2A is an overview of the high voltage bus showing the relationship between the voltage at the bus bar centrally located in the electronics compartment of the vehicle according to one embodiment of this invention;

FIG. 2B is an overview of one embodiment of a flight controller computer for enabling battery management systems through high voltage to assign unique identifiers that allow for unlimited removable battery packs to be used by a vehicle;

FIG. 2C depicts a scenario where limited range would be a problem for a roundtrip flight without replaceable/rechargeable battery packs according to aspects of this invention;

FIG. 3A illustrates the flight control computer architectural layering and design;

FIG. 3B illustrates a tubular pressurized frame according to one embodiment of the vehicle of this invention;

FIG. 3C is a side elevational view of the frame of FIG. 3B;

FIGS. 4A-4B are side elevational views of a seat assembly in unloaded and loaded configurations, respectively, according to one embodiment of this invention;

FIGS. 5A-5D are perspective views of the seat assembly according to various aspects of this invention; and

FIGS. 6A-6C are cross-sectional views of various components of the seat assembly according to one embodiment of this invention.

### DETAILED DESCRIPTION OF THE INVENTION

The invention can be implemented in many ways, including as a process; an apparatus; a system; a flying vehicle, a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless otherwise stated, a component such as a processor or memory described as being configured to perform or complete a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

Various embodiments of a single operator electric vertical takeoff and landing transportation vehicle 10 are described herein, henceforth referred to as the “vehicle”. In some embodiments there may be a varying number of propulsion modules 12. The number of propulsion modules 12 can be as low as two units and the maximum is unlimited and any number of modules in between. The proposed embodiment's design is for optimal operator safety and reduced risk of harm to person and/or the vehicle 10 in such a way that it would no longer be able to operator safely. In any embodiment, the propulsion modules 12 act as standalone units, but have a balancing capability using a voltage bus 14, connected with a higher resistance wire, designed to keep battery packs 202 at similar voltages by allowing more current to flow through the wire. The battery voltage bus 14 places all battery packs 202 in a parallel configuration to optimize power draw and balancing at the same time.

For the purposes of clarity, technical material that is known in the technical fields related to the invention have not been described in detail so that the invention is not unnecessarily obscured.

Each battery pack 202 is directly connected to an electronic speed control module (ESC) 18 that drives the voltage of a motor 200 to increase or decrease the revolutions of the motor 200 per minute (RPM's). A shorter, lower gauge wire, with less resistance, is used between the battery pack 202 and the ESC module 18 to ensure the proper voltage and amperage is flowing to the motor 200.

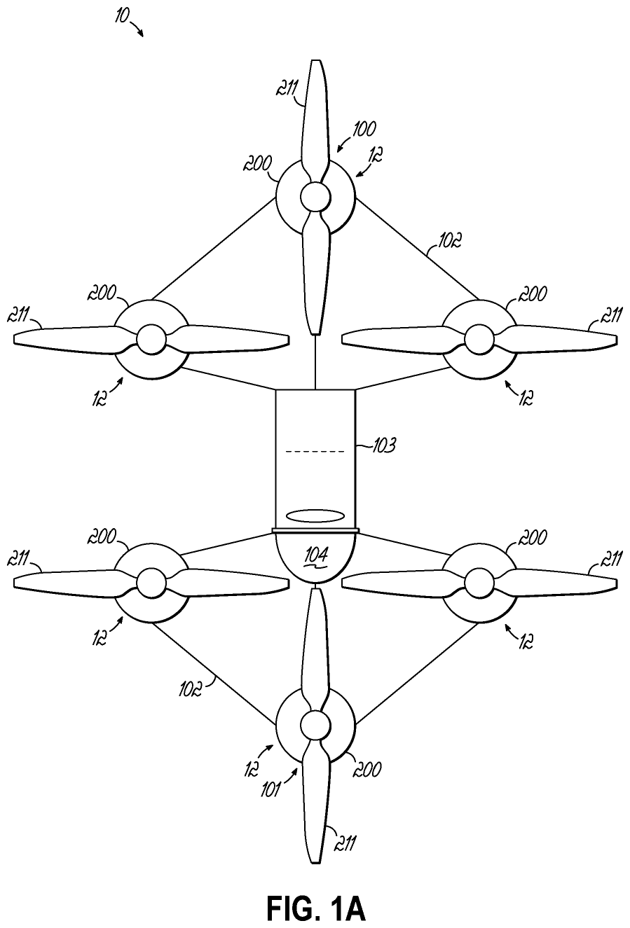

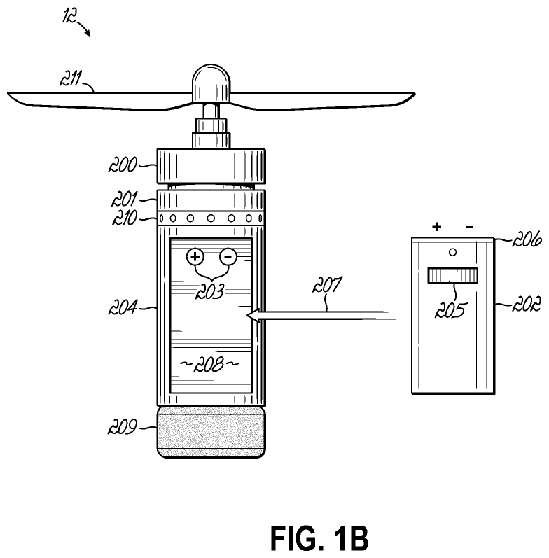

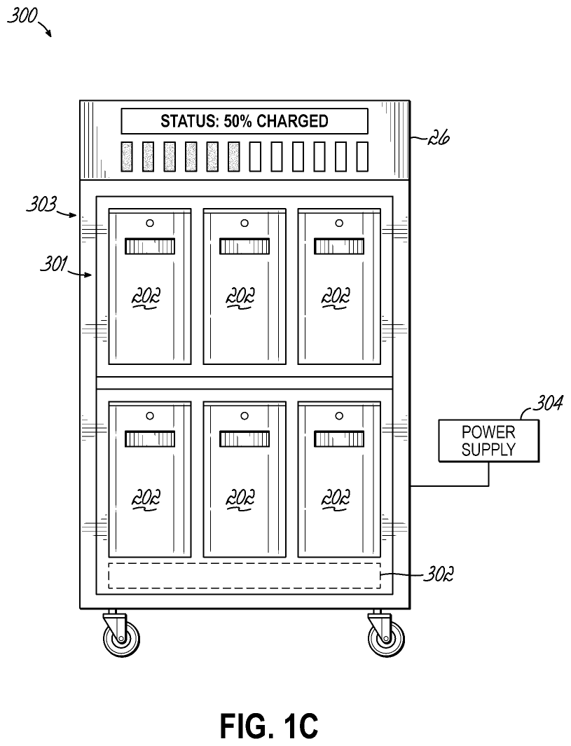

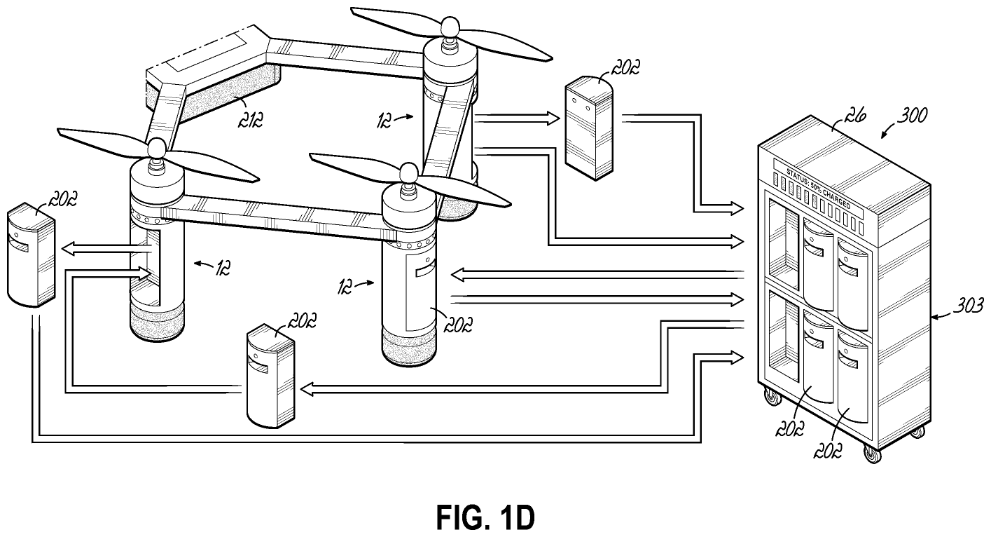

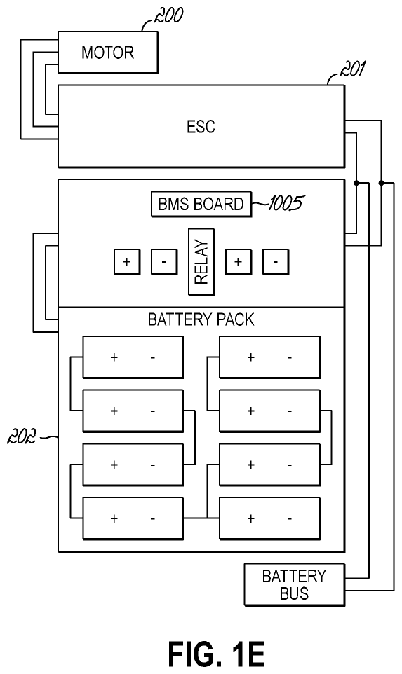

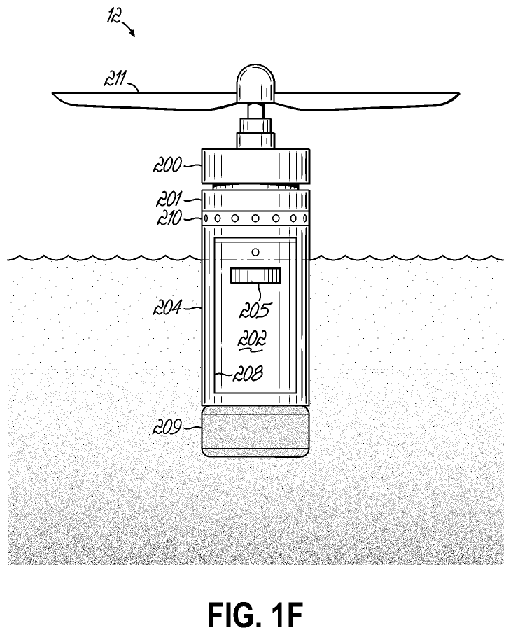

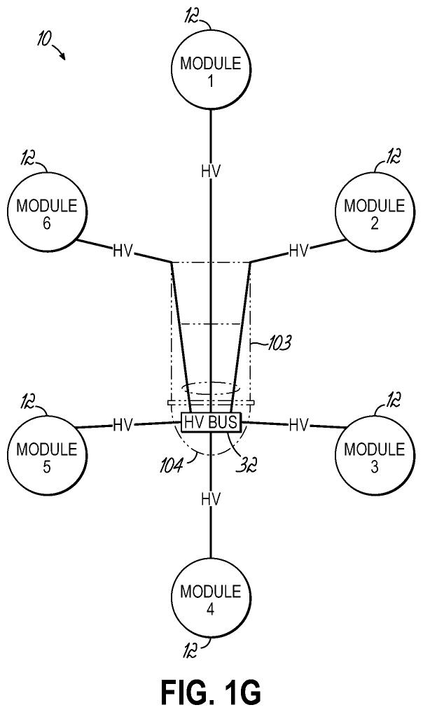

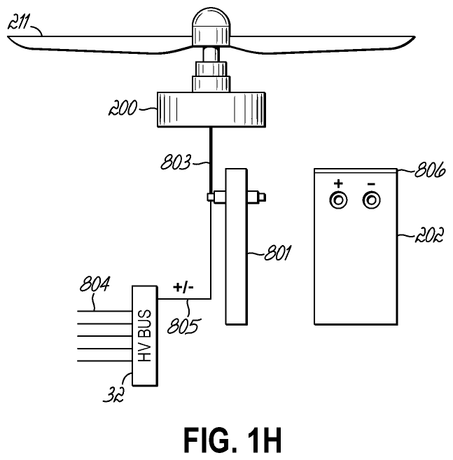

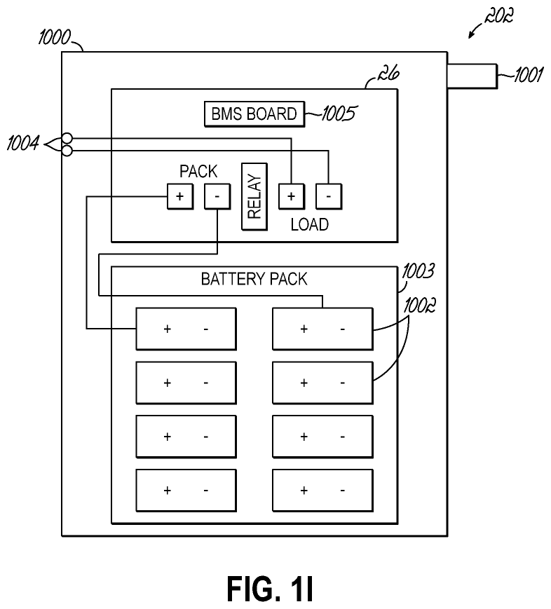

FIG. 1A is an overview drawing displaying the overhead view of the flying vehicle 10. The structure and major components of the vehicle 10 are shown in FIG. 1A. In this embodiment, the vehicle 10 has six propulsion modules 12, each of which may include: one motor 200; one propeller 211; one electronic speed control modules (ESC) 18; one battery pack 202; one high voltage light ring 210; and one battery management system (BMS) 26. FIG. 1A identifies the forward portion 100 of the vehicle 10; the aft portion 101 of the vehicle 10; an exemplary frame arm 102 for carrying wiring; a cockpit/operator compartment 103; and an electronics and high voltage bus compartment 104. Wiring is strung from each propulsion module 12 to the electronics and high voltage bus compartment (ECOM) 104.

Each propulsion module 12 is controlled independently by a vehicle Flight Control Computer (FCC) 28 located in the ECOM 104. Hence, each propulsion module 12 is standalone other than it contains a high voltage connection to the other propulsion modules 12 for purposes of balancing the battery packs 202 and a network connection to the FCC 28. In one embodiment, the implementation of the frame 30 is constructed for optimal flight control with the requirement that the propulsion modules 12 be far enough away from one another, should a fire occur in one of the propulsion modules 12 or its battery pack 202, it would not become hot enough to affect an adjacent propulsion module 12 and the vehicle 10 can continue to be controlled safely.

FIG. 1B illustrates one embodiment of the propulsion module 12 including the motor 200; an electronic speed control module 201; the structural enclosure 210, which houses the removable battery pack 202; heavy-duty plug/lock power connectors 203; removable battery pack 202; battery pack handle 205 for easy removal of the battery pack 202; battery management system circuit board 206; outrigger floatation unit 209; high voltage light ring 210; propeller 211. The removable battery pack 204 is loaded 207 into a propulsion enclosure 208.

One embodiment of this invention has the floatation unit 209 in association with the airtight battery pack 204 which act together in the process of dissipating water across all propulsion modules 12 to assist a central fuselage outrigger floatation device 212 to keep the vehicle 10 afloat. Depending on vehicle weight, the size of the outrigger flotation device 212 should handle the majority of the floatation and the removable battery pack 202 would only descend approximately two-thirds under water at landing (FIG. 1F).

Another aspect of some embodiments of the vehicle 10 includes a fuselage float. The fuselage float displaces the majority of the water and it is used in conjunction with the outrigger floats 212 for buoyancy. The fuselage float may be comprised of a bladder and a covering that is waterproof. It is strapped into the frame with waterproof laces to maintain its position inside the frame. The fuselage float can be made up of a single or multiple floats.

FIG. 1F illustrates the removable battery pack 202 submerged at its furthest decent where the module enclosure 502 is housing the battery pack 202 and has the outrigger flotation unit 212 attached and waterproof. The added dissipation is helpful during a hard landing or when extra operator weight is added. The calculations surrounding this are based on the number of propulsion modules 12; the size of the outrigger floatation device 212; the overall weight of the vehicle 10; and the necessary displacement of liquid necessary to achieve the proper buoyancy.

FIG. 1I is an illustration of one embodiment of the battery pack 202 representative of a self-contained set of battery cells 1002 that may be, but are not limited to, a series of cells 1002 connected to a specific configuration to achieve the proper voltage and current. The cells 1002 are encased in a sealed structure 1003 that may be made of a light plastic or carbon fiber material. The sealed encasement 1003 could contain a series of thermistors, but is not limited to any thermal measuring. The pack's 202 positive and negative leads are routed through a sealed connection, which may be waterproof, so as to connect them to the battery management system 26.

The entire pack enclosure 1000 has a circuit board 1005 of the BMS 26 mounted on top of the pack enclosure 1000. The LOAD leads are run to two locking ports 1004 that in this embodiment are keyed on the back of the pack enclosure 1000 and these points will connect into the associated propulsion module 12 housing at equally keyed connectors of opposite gender or polarity. On the other end of the sealed pack is a handle 1001 for easy pull-out removal of the pack 202 from the propulsion module 12. An additional status light, in this embodiment, maybe mounted for informational purposes regarding the active state of the battery pack 202.

The following illustrations describe the purpose of the rechargeable battery system 26 according to one embodiment of this invention.

FIG. 1D is an illustration of one embodiment of a battery replacement scenario according to this invention. Batteries used in an ultralight vehicle need to be lightweight to comply with FAA specifications. This means the batteries will have limited time before discharge. This embodiment with multiple propulsion modules 12 would require replacement and/or recharging as battery life diminishes for further operation. With a removable battery pack 202 this can be accomplished by removing the battery packs 202 and replacing them with recently charged battery packs 202.

When the propulsion module's battery 202 life is low, the rechargeable battery pack 202 is pulled from the module 12 and placed in the battery charging system 300. This battery 202 can then be charged and used later in any propulsion module 12. We see that for each propulsion module 12, the battery pack 202 may be pulled and moved to the battery charging system 300 and a fully charged battery pack 202 may be pulled from the charging station 300 and moved back into the any propulsion module 12. Similarly any propulsion module 12 without a battery in it may have a battery pack 202 taken from the battery charging system 300 and placed into the propulsion module 12.

In this embodiment, the battery packs 202 are anonymous when added to the propulsion enclosure and only addressed for purposes of serializing tracking of the physical hardware. When placed in the vehicle 10 via the propulsion module's propulsion enclosure, they are then programmatically assigned a unique identifier associated with that particular propulsion module 12 (see FIG. 1G).

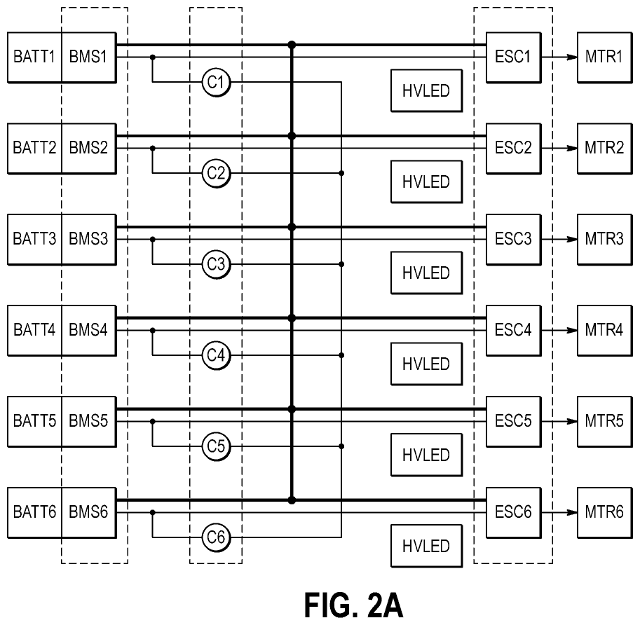

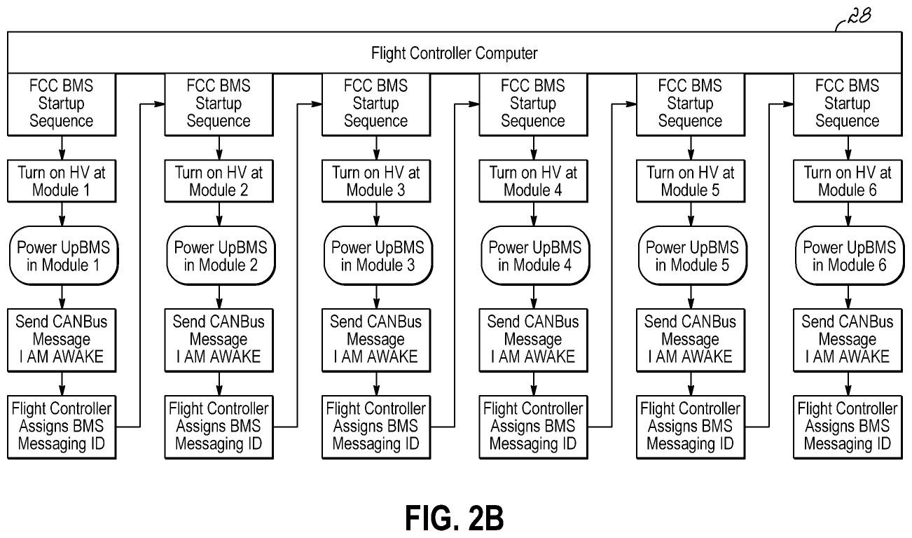

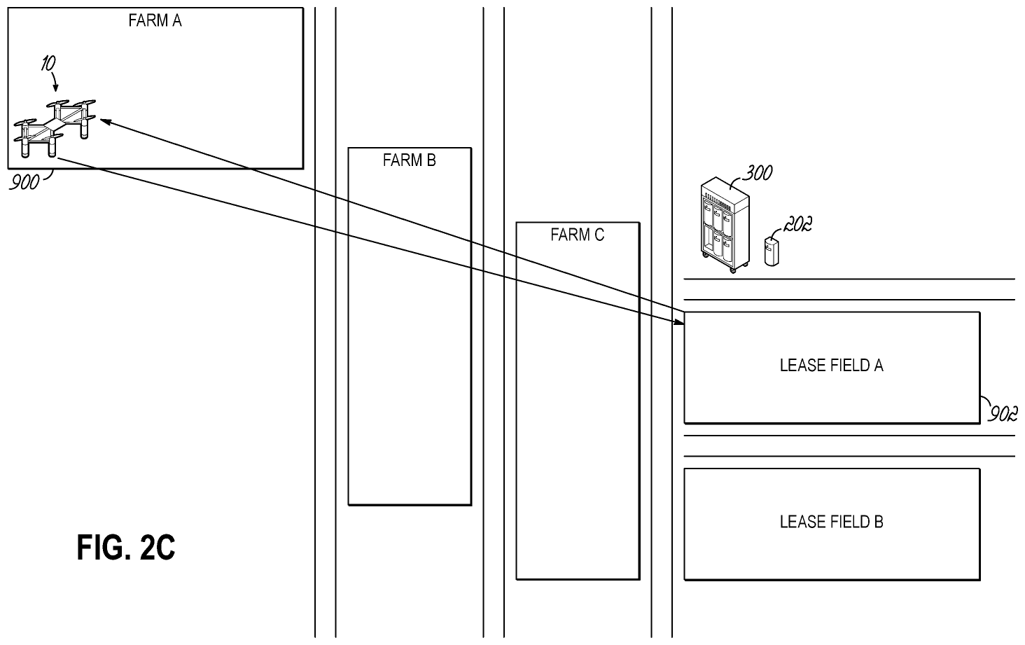

One embodiment as shown in FIG. 1G illustrates a six-propulsion module environment. Here each pack 202 is loaded into its propulsion module 12. High Voltage is run to each module 12 and which are connected via a high voltage bus 32 where each propulsion module 12 receives high voltage only when the contactor for each propulsion module 12 has a closed circuit (FIG. 2A). When high voltage is available at the module 12, then the BMS system 26 becomes active and the BMS can be initialized.

FIG. 2B is a diagram showing the Flight Controller Computer (FCC) 28 beginning its startup sequence for powering the high voltage flow. Each module 12 is sequenced in order. High voltage is supplied to wake up the BMS 26, the BMS 26 then sends a message to the FCC 28 who will then assign a messaging identifier to the BMS 26 to use during the flight. Once one BMS 26 is messaging successfully with the FCC 28, it moves to the next module 12. This process is replicated when charging the batteries 202 in the battery charging system 300.

In one embodiment, the voltage of the various battery packs 202 needs to stay within a range, usually one to two tenths of each other, during discharge. This is to assure the vehicle operator that they have enough range and range calculations can be performed easily. To accomplish this, the high voltage bus 32 is used.

FIG. 1E illustrates one embodiment of a detailed configuration of power connections of the propulsion module 12 and the removable battery pack 202. The BMS Board 1005 connects to battery cells in parallel and/or in series to obtain the proper voltage and amperage. The pack 202 connects through a series of relays to the LOAD side. The electronic speed control unit 201 only receives power when everything is properly connected via high voltage 32. The ESC 18 provides power to the motor 200 provided through an additional pulse width modulation signal suppled via low power from the flight control module 28. The same LOAD is connected to the high voltage bus 32.

FIG. 1H is an illustration of how the high voltage is managed between the high voltage bus 32 and the load used by the motor 200. The removable battery pack 202 with battery management system 26 are a standalone-controlled until that is plugged into the propulsion enclosure on the propulsion module 12. The connection is engaged through the LOAD side of the BMS 26. As each motor 200 draws current through a low resistance, short distance power line 803 of DC power, the high voltage bus 32 is also connected to high resistance wire that will help balance the battery packs in each module.

Just as this battery pack 202 is in parallel with each of the other modules 12 and the load is drawn across all packs 202, the packs 202 will balance each other with the high resistance 804. When current flows through the lines the high resistance, a principle of Ohm's Law, causes the other independent battery packs 202 to level at the same voltage. Each of the battery packs 202 will rise in voltage to the voltage of the highest pack.

Referencing FIG. 1G shows the high voltage across the other modules 12.

The following illustrations depict the purpose of the external battery charging system 300. In one embodiment, an external battery charging system 300 provides some very useful purpose. If the mechanism is a rolling cart or similar, it can be moved around easily and house additional removable battery packs 202 that are charged and ready for use once the vehicle packs 202 are discharged beyond effective use.

In one embodiment, additional range from one point to another may be necessary and by using an automotive vehicle, the packs 202 could be easily charged and retrieved using a battery charging system 300.

FIG. 1C depicts a battery charging system in this embodiment is comprised of a rolling cart 303 that could instead be gas powered or an electric powered automobile. The charging system 300 is comprised of a display and battery management system (BMS) 26; a set of removable/rechargeable battery packs 202; an AC to DC inverter 302; and external power supply 304.

As each pack 202 is engaged in the battery charging system 300, it is seen by the FCC 28 that will follow the same process as FIG. 2B but instead of being prepared to draw power for propulsion, it is prepared for receiving power through the inverter 302.

One possible scenario that takes advantage of the rechargeable/replaceable battery packs 202, but for which this invention is not limited to, follows.

FIG. 2C illustrates one aspect of this invention where a vehicle 10 needs to go beyond its range to and from the destination. In this scenario, a vehicle's range is 50 miles. To go from FARM A to the destination at FIELD A it is 30 miles. Which indicates that the vehicle will not be able to return to FARM A without recharging its batteries or having replacement batteries at FIELD A. If an automotive battery charging system or a rolling cart recharging system 300 is available at FIELD A, the operator of the vehicle 10 can replace the vehicle battery packs 202 and continue back to FARM A with no additional issues.

The packs 202 left at FIELD A 902 can be charged and used later. The battery recharging system 300 could also be temporarily located at FIELD A 902 and then later returned to FARM A 900 for a later deployment somewhere else.

In one embodiment, each propulsion module 12 is managed by a central flight control system 28 to ensure stable and controlled flight. Stable and controlled flight is achieved through the use of factors involving, but not limited to, operator input, environmental instrumentation, vehicle instrumentation, third party remote data sources, all being accessed while in flight. To manage and control a multitude of electric motors 200 and perform responsive thrust management to maintain stable flight; ascending flight, descending flight; forward flight; and maneuvering flight, the flight control computer 28, these inputs used on all three flight axis to control the vehicle 10 in an unlimited set of possibilities. Below is described various non-limiting field of inventions technology to achieve this.

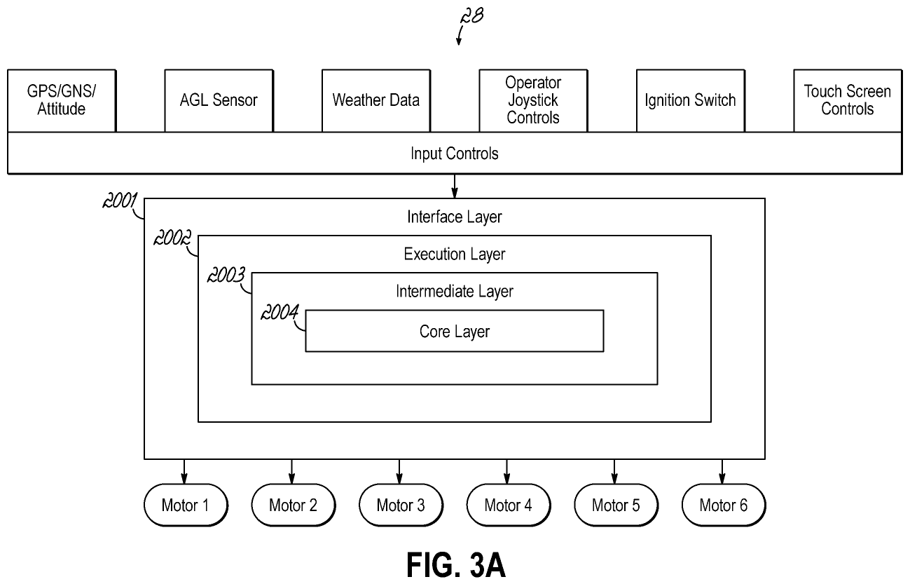

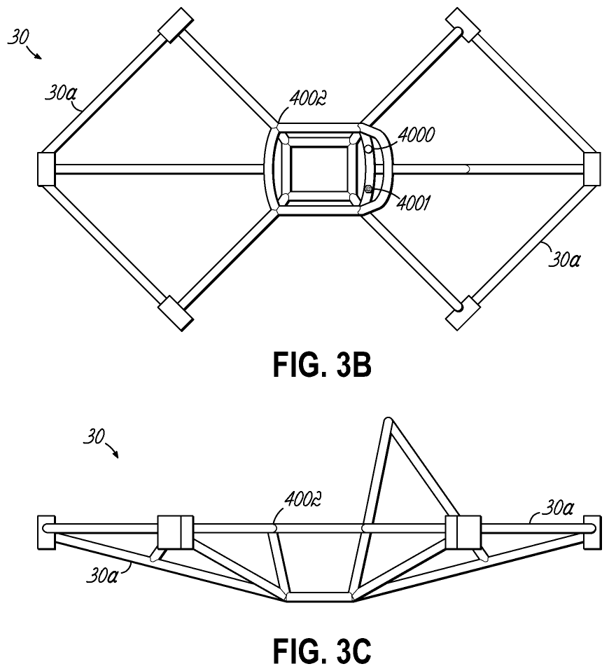

FIG. 3A illustrates one embodiment of the flight control computer 28 architectural layering and design. The system hierarchically represents level of execution and commands based on input, hand-written code to control specific functions and flight characteristics of the flying vehicle 10 and the outputs based on an algorithmic design that incorporates both hand-coding and model-generated code to command each motor to perform the task represented from the inputs.

All input is processed through the interface layer 2001 of the FCC 28. The inputs are managed through drivers written to take device or signal input that could be, but not limited to digital or analog signaling. The inputs are processed to a normalized internal structure that organizes the data so it can be easily passed between system layers.

The execution layer 2002 is the layer where processing assessment and command request and response occurs. This layer 2002 will manage the state of the system as well as the logging for debugging and component assessment and management. It will provide logical system data management for the inner layers that process flight and vehicle characteristics.

When the execution layer 2002 passes data to the intermediate layer 2003 flight control tasks such as, but not limited to, hover, move forward, accelerate, and attitude are being calculated for execution. This layer 2003 is a combination of auto-generated code based on simulation and human considerations.

This layer 2003 rated data analysis, such as, but not limited to, have fast to accelerate or how slowly will the vehicle 10 land in varying configurations. The limiting of generic modeling data that accounts for human intuitiveness is built into this layer 2003. However, this layer 2003 does not make decisions alone. It relies on the core layer 2004 to handle complex sensor data and standum data from all systems.

The core layer 2004 is built based on complex modeling and simulation based on aerodynamic characteristics and input analysis. This layer 2004 is developed through modeling and simulation and is auto-generated code that is plugged into the flight control computer 28. Utilizing the driver data structures created at the interface layer 2001 and used at every intermediate layer 2003, this layer 2004 acts independent of the intermediate layer 2003. The intermediate layer 2003 takes data from the core layer 2004 and creates and execution strategy around the core constructs. The intermediate and core layers 2003, 2004 work together to provide the best flight characteristics for the vehicle 10.

When everything in the execution is determined at the intermediate layer 2003, the commands are passed back through the execution layer 2002 to the interface layer 2001 and to the propulsion modules 12, each module 12 receives its power commands to perform the associated tasks.

This process is running at very high frequency so input and control can be varied on the simplest of changes to any input.

The system of the flying vehicle 10 requires a lightweight frame 30 to comply with Federal Aviation Administration regulations associated with the ultralight class of vehicle. To assure frame integrity, the lightweight frame 30, in one embodiment, may be pressurized with a lightweight gas.

FIG. 3B illustrates a tubular pressurized frame 30 where the pressure can be measured with a pressure sensor 4000 and be filled and maintained by way of a standard valve connection 4001. The core sections of the frame 30 are connected with full-seal welds 4002 demonstrates a side view of the frame 30 where all the core points are connected via the lightweight tubing 30a.

Should the lightweight frame 30 crack, the pressure sensor 4000 would provide input feedback to the flight control computer 28, similarly, but not limited to, to all other inputs, to inform the vehicle operator that flight is not recommended.

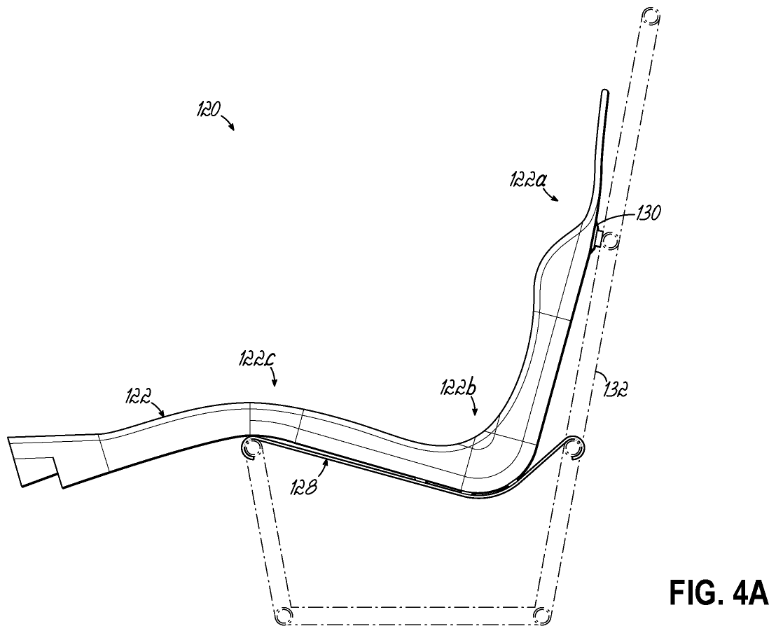

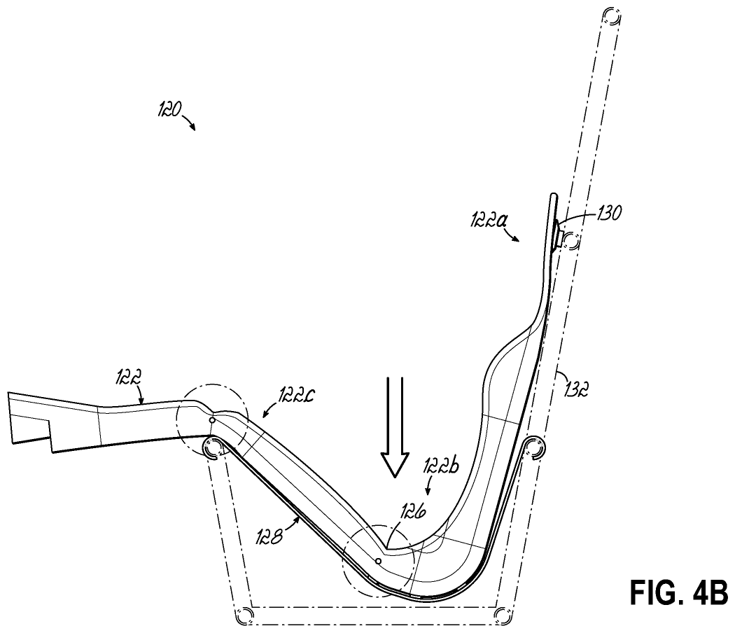

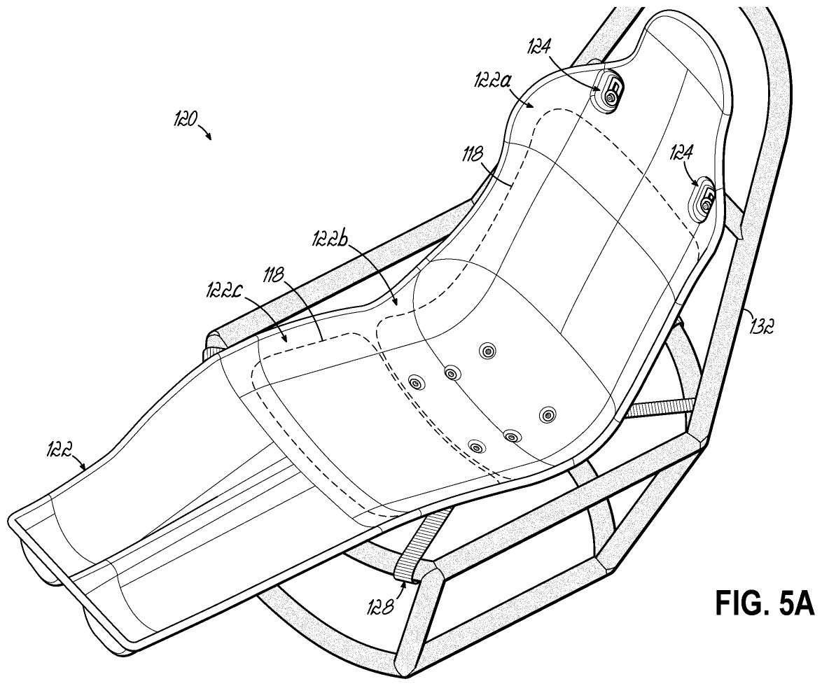

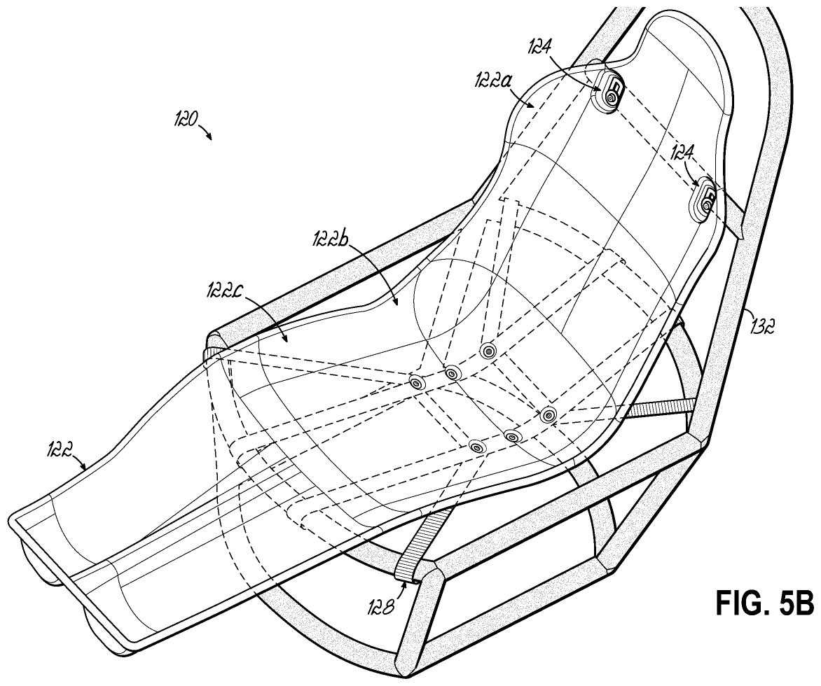

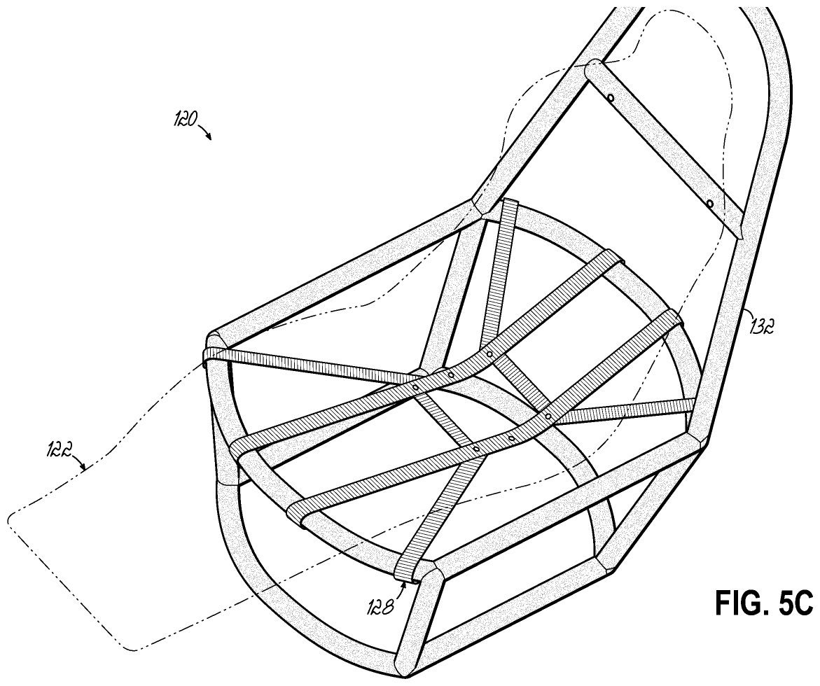

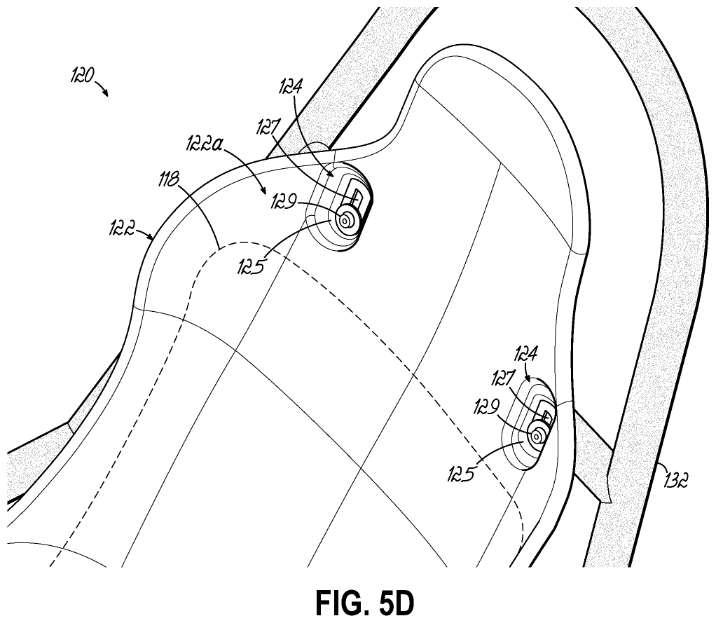

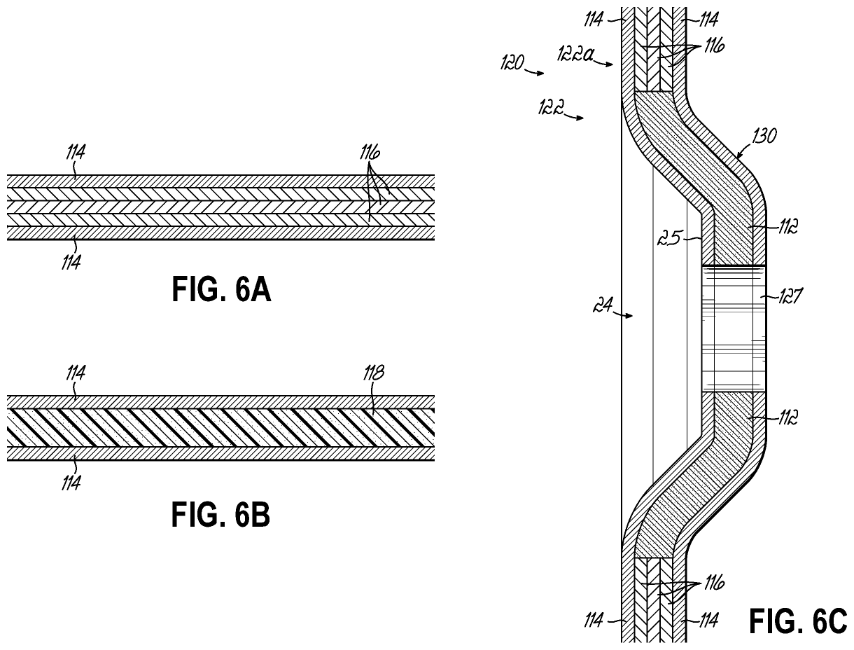

Another aspect of various embodiments of this invention is shown in FIGS. 4A-6C in which a seat assembly 120 is shown. This embodiment of the seat assembly 120 includes four main materials from which the seat assembly 120 is constructed. These four main materials include carbon fiber 114, Kevlar 116, foam core 118 and fiberglass 112 as shown in FIG. 6A. The seat assembly 120 may have three inner layers of Kevlar 116, covered front and back by an outer layer of carbon fiber 114 as shown in FIG. 6B. The seat assembly 120 includes a seat 122 having shoulder mount pockets 124 (FIG. 5A) which contain no Kevlar, they are only fiberglass 112 covered with carbon fiber 114 on the inside and outside. (FIG. 6C). The shoulder mount pockets 124 in one embodiment include a recessed area 125 with a slot 127 in a well of the recessed area 125 and a bolt 129 or another fastener extends through the slot 127 to secure the upper portion of the seat 120 to the seat frame 132. The bolt 129 may be frangible at a force threshold to allow the seat to shift downwardly in the event of a hard landing or other situation.

Alternatively, the pockets 124 may rupture at a force threshold. There is no Kevlar 116 in the pockets 124 by design because they are meant to break in the event of a vertical drop. Foam core 118 is used to add support to the back 122a, hips 122b and upper leg 122c areas of the seat 122. A channel 126 is formed below the hips 122b that does not have any foam core to allow the seat 122 to bend. The seat 122 is designed to bend, but not break in a vertical drop, keeping the occupant safe. The bottom or hip area 122b of the seat 122 is supported by a matrix or web 128 made of shock absorbing nylon strap. The web 128 is designed to stretch 12″ in a 20 ft. drop, decreasing the vertical shock transmitted to the pilot. As seen in FIG. 4A, a side view of the seat assembly 120 as installed. After a vertical drop as illustrated in FIG. 4B, shoulder mounts 130 have sheared from the pockets 124, the webbing 128 has stretched allowing the back 122a of the seat 122 to slide down, still supported by the webbing 128. As the seat 122 drops, in a frame 132 of the seat assembly 120, the seat 120 bends at the hips 122b and the knees as shown in the circles A and B of FIG. 4B.

FIG. 5A shows the shoulder mount pockets 124, containing fiberglass and carbon fiber, but no Kevlar. FIG. 5A also shows the layout of the foam core 134 in the seat 122. FIG. 5B shows the seat 122 mounted in the frame 132. FIG. 5B also shows the seat 12 attached to the webbing 128 via bolts 136. FIG. 5D shows the back 122a, including a shoulder region, bolted to the frame 132 via the shoulder mount pockets 124. The front of the shoulder pocket 124 is shown in FIG. 5D and the webbing 128 mounted in the frame 132 and bolted to the seat 122 is shown in FIG. 5C.

These foregoing embodiments of the invention are exemplary only and in no manner should be viewed as exhaustive or limiting on the scope of this invention. Alternative numbers of components, method steps, materials, parameters, arrangements and other aspects may be utilized within the scope of this invention.

From the above disclosure of the general principles of this invention and the preceding detailed description of at least one embodiment, those skilled in the art will readily comprehend the various modifications to which this invention is susceptible. Therefore, we desire to be limited only by the scope of the following claims and equivalents thereof.

We claim:

1. An eVTOL system comprising:
an eVTOL having
a first plurality of propulsion modules, wherein each of the plurality of propulsion modules further comprises:
a motor;
a propeller operatively coupled to the motor to be rotationally driven by the motor;
a battery pack operatively coupled to the motor for powering the motor;
a frame to which each of the first plurality of propulsion modules is mounted;
a seat assembly mounted to the frame for accommodating a pilot of the eVTOL;
a flight control computer for controlling operation of the eVTOL;
a battery management system operatively coupled to the flight control computer for managing the eVTOL;
a second plurality of battery packs; and
a battery recharging station adapted to selectively charge the first and the second plurality of battery packs;
wherein each of the first plurality of battery packs and the second plurality of battery packs is adapted to be coupled to each of the first plurality of propulsion modules such that when the first plurality of battery packs is installed in the associated ones of the propulsion modules and discharged, select ones of the second plurality of battery packs may be installed in the associated propulsion module for continued operation of the eVTOL.

2. The system of claim 1 wherein the battery recharging station is mobile and distinct from the eVTOL.

3. The system of claim 1 wherein each of the first plurality of propulsion modules further comprises:
a floatation device.

4. The system of claim 1 wherein the eVTOL further comprises:
a high voltage bus operatively coupled to each of the first plurality of propulsion modules.

5. The system of claim 1 wherein the flight control computer further comprises:
an architecture having an interface layer, an execution layer, and intermediate layer and a core layer.

6. The system of claim 1 wherein each of the first and second pluralities of battery packs further comprises:
a plurality of battery cells;
at least one locking power connector;
a status light; and
a watertight enclosure.

7. The system of claim 1 wherein the battery management system is adapted to balance a charge level of each of the first plurality of battery packs while the eVTOL is actively in flight.

8. The system of claim 1 wherein each of the plurality of battery packs further comprises an enclosure which is sealed and adapted to act as a floatation device.

9. The system of claim 1 wherein at least portions of the frame have a tubular construction in which an interior of tubular construction has an increased pressure which is greater than an ambient pressure.

10. The system of claim 9 further comprising:
a pressure sensor to measure the increased pressure in the interior of the tubular construction; and
an alarm to provide a warning when the pressure sensor measures the increased pressure which is below a threshold.

11. The system of claim 1 wherein the seat assembly further comprises:
a seat;
a matrix of webbing supporting the seat and coupled to the frame.

12. The system of claim 11 further comprising:
a pair of shoulder mounts which couple a shoulder region of the seat to the frame, wherein each shoulder mount is frangible above a threshold force.

13. The system of claim 11 further comprising:
a channel in the seat proximate a hip region of the seat, the seat being adapted to bend about the channel when the seat is forced downwardly relative to the frame.

14. The system of claim 11 wherein the seat is constructed of fiberglass, carbon fiber, Kevlar™ and foam materials.

15. A method of operating an eVTOL system comprising:
a charging a first plurality of battery packs;
installing each of the first plurality of battery packs into one of a first plurality propulsion modules of an eVTOL;
flying the eVTOL by a pilot seated within a seat assembly of the eVTOL;
monitoring the charge status of each of the first plurality of battery packs;
charging a second plurality of battery packs remotely from the eVTOL;
removing select ones of the first plurality of battery packs from the associated ones of the first plurality of propulsion modules;
installing select ones of the second plurality of battery packs in those of the first plurality of propulsion modules needing a battery pack; and
resuming flying of the eVTOL with at least some of the second plurality of battery packs.

16. The method of claim 15 further comprising:
recharging the select ones of the first plurality of battery packs removed from the associated ones of the first plurality of propulsion modules.

17. The method of claim 15 wherein the flying step further comprises:
rotating a first plurality of propellers with a first plurality of motors each powered by one of the first plurality of battery packs coupled with the associated one of the first plurality of propulsion modules.

18. A seat assembly for a flying vehicle comprising:
a frame of tubular members coupled within the flying vehicle;
a matrix web of shock absorbing straps secured to the frame;
a seat supported on the matrix web of shock absorbing straps; and
a frangible connection between at least a part of the seat and one of the frame and the matrix web such that upon a force exerted upon the seat assembly the frangible connection breaks allowing the adjacent portion of the seat to translate relative to the frame.

19. The seat assembly of claim 18 wherein the frangible connection further comprises:
a recessed pocket in the seat proximate a shoulder region of the seat;
an aperture in the recessed pocket; and
a fastener extending through the aperture in the recessed pocket to couple the seat to the frame.

20. The seat assembly of claim 18 wherein the following materials are used to construct the seat: fiberglass, Kevlar™, carbon fiber and foam.
